(19) United States
(12) Patent Application Publication
(10) Pub. No.: US 2008/0156837 A1
(43) Pub. Date: Jul. 3, 2008

(54) Automobile garment hanging device

(76) Inventor: Ron F. Brightman, Cheshire, CT (US)

Correspondence Address: H. Jay Spiegel and Associates PC, P.O. Box 11, Mount Vernon, VA, 22121, US

(21) Appl. No.: 11/646,258

(22) Filed: Dec. 28, 2006

(51) Int. Cl. B60R 7/10; A47G 25/14

(52) U.S. Cl. 224/313; 223/85

(57) ABSTRACT

An elongated garment hanger for use in the rear seat section of an automobile interior providing a means to carry several clothes hangers with garments thereon in such a manner as to not impede the driver's view through the rear window and comprising a rear support member which rests on the rear package shelf behind the rear seats, a handle hook which simply hooks over the grab handle, and a hanger bar which is removably suspendable between the rear support member and the hanger hook and on which garments are hung using common clothes hangers.

### FIELD OF THE INVENTION

This invention relates generally to garment hanger devices for use in automobile interiors, and more particularly to an elongated garment hanger for use in the rear seat section of an automobile interior providing a means to carry several clothes hangers with garments thereon in such a manner as to not impede the driver's view through the rear window.

### BACKGROUND OF THE INVENTION

Many automobiles are not equipped with the conventional small clothing garment hooks located near the ceiling above the rear side windows or rear portion of the vehicle. Instead, many automobiles are now provided with a grab bar or grab handle located near the ceiling, or on the ceiling, above the rear side windows of the vehicle. Some of these handles may have a very small hook associated with them from which one or, at most two, wire clothes hangers may be suspended. Because the small hooks are incapable of holding a large number of garments, they are not functional for use when traveling, picking up garments from the dry cleaners, and other times when large hanging capacity is desired.

In an attempt to overcome this deficiency, vehicle owners often hang their clothing garments, on hangers, directly over and through the grab handles located in the vehicles. Due to the design and location of the grab handles in relationship to the ceiling of the vehicle, it is often difficult, and in some cases impossible, to pass the hook of the conventional clothes hanger through the opening between the grab handle and the ceiling of the vehicle. Also, it is possible, when inserting or removing the clothes hangers in this manner, to damage or tear the material forming the headliner of the ceiling in the vehicle. Also, the direct contact and sliding movement of the hangers against the grab handle has a tendency to wear, tear, crack and damage the grab handles. For these reasons, many vehicle owners will not hang clothes hangers directly over and on the grab handles.

Even if the vehicle owner does place conventional clothes hangers on the grab handles, the garments tend to be pushed against the windows and doors of the vehicle due to the position of the grab handle. Also, many grab handles are designed such that they retract into or against the inside surface of the vehicle, tending to pull the garments with them. This increases the tendency toward wrinkling and soiling of the garments. In addition, the garments bunch up against the inside of the vehicle and are pushed outward into the driver's field of view, thus obstructing vision through the rear or side windows.

Devices are known which can be attached to the existing clothes hooks or grab handles in vehicles to increase hanging capacity. One common device is an elongate bar which is supported at opposite ends on the existing hooks or grab handles and extends across the rear passenger compartment of the vehicle from one side to the other. However, when clothes are hung on this type of device, the driver's view through the rear window is obstructed and the back seat is not available for passengers.

Seidler, U.S. Pat. No. 2,528,794 and Kramer, U.S. Pat. No. 2,728,503 disclose garment hangers which require installation and adaptation to a vehicle's interior, thus allowing the hanging of clothing garments in vehicles in which no factory installed clothing hook is provided, but these hanging devices are extremely mechanical and complex in construction and would not be practical in modern automobiles.

Shannon, U.S. Pat. No. 5,104,083 and Gabbert, U.S. Pat. No. 4,863,081 disclose garment hangers with adaptable depth adjustment mechanisms, so as to fit the various interior trim angles on which fixed garment hooks are usually located, but their use and adaptability to the small garment hooks often associated with grab handles is impossible due to the distance at which the grab handles are located away from the trim or ceiling of an automobile.

White, et al., U.S. Pat. No. 4,778,089 discloses a telescoping rod which is adapted to be supported from beneath an interior grab handle of the vehicle. However, this device lacks lateral support and is subject to swinging or pivoting when garments are placed on it and the vehicle is in motion.

Francis, U.S. Pat. No. 2,640,634 and Wachowski, U.S. Pat. No. 2,634,892 disclose garment supports which do not require an existing garment hook or grab handle and provide a longitudinal rod on which to hang multiple garments. However, they are mechanically complex to set up and adjust within modern automobiles.

The present invention is distinguished over the prior art as a simple means for providing increase hanger space for clothing in an automobile while not impeding the driver's view. In that, the present invention comprises essentially three parts: a rear support member which rests on the rear package shelf behind the rear seats, a handle hook which simply hooks over the grab handle, and a hanger bar which is removably suspendable between the rear support member and the hanger hook. The rear support member comprises an L-shaped structure having unequal length legs with each leg provided with an aperture to receive one end of the hanger bar. When the rear support member is positioned on the rear package shelf, it rests on one leg with the other leg extending upward behind and above the rear seat headrest. Apertures at the ends of the legs receive one end of the hanger bar which extends forward over the rear seat. The handle hook is provided with a hook portion that fits over the grab handle, and a body portion having upper and lower apertures to receive the other end of the hanger rod. The weight of clothes suspended from the hanger rod is sufficient to prevent movement of the device and the hook portion of the handle hook has a sufficient thickness to bias the grab handle outward thereby keeping the hanger rod a sufficient distance from the interior surface of the automobile to avoid bunching and wrinkling of clothes hung thereon. The combination of the unequal length legs of the rear support member and the upper and lower apertures on the handle hook provide height adjustment to accommodate vehicles with rear seat headrests of different heights. In addition, by suspending the hanger bar from the handle hook, the level of the bar and the clothes hung thereon is no higher than the rear seatback thereby avoiding the problem of interfering with the driver's rear view.

### SUMMARY OF THE INVENTION

It is therefore an object of the present invention to provide an automobile clothes hanger device which will greatly increase the number of garments which can be hung in a vehicle without impeding the driver's vision.

It is a further object of the present invention to provide an automobile clothes hanger device which does not require modification of the interior of a vehicle.

It is a still further object of the present invention to provide an automobile clothes hanger device which is easy to install and remove without tools.

It is an even further object of the present invention to provide an automobile clothes hanger device which can be used on either side of a vehicle.

These and other objects and advantages are accomplished by an automobile garment hanging device comprising: a rear support member adjustable to different heights, a handle hook removably attachable to an automobile grab handle, and a hanger bar longitudinally suspendable between the rear support member and the handle hook within a vehicle interior.

In addition, these and other objects of the present invention are accomplished by an automobile garment hanging device comprising: a rear support member comprising a substantially L-shaped bracket having unequal length legs, each leg having an aperture at the free end thereof, the bracket adapted to be positioned on a rear window shelf of an automobile passenger compartment, a handle hook comprising an elongated body having upper and lower apertures therein and a hook member extending laterally from one end of the body adjacent to the upper aperture, the hook member adapted to engage an automobile grab handle whereby the elongated body is suspended from the grab handle, and an elongated hanger bar engagable with one of the apertures in the rear support member and one of the apertures in the handle hook to be suspended therebetween over a rear seat of an automobile to receive clothes hangers thereon.

### BRIEF DESCRIPTION OF THE DRAWINGS

FIG. 1 is an oblique view of the automobile garment hanging device of the present invention showing the rear support member, the handle hook and the hanger bar in their operational relationship.

FIG. 2 is a view of the rear support member.

FIG. 3 is a view of the handle hook.

FIG. 4 is a view of the hanger bar.

FIG. 5 is a view of the automobile garment hanging device in position within a vehicle.

FIG. 6 is a view of an alternative embodiment of the rear support member.

FIG. 7 is a view of an alternative embodiment of the handle hook.

FIG. 8 is a view of an alternative embodiment of the hanger bar.

FIG. 9 is a view of a further alternative embodiment of the rear support member.

FIG. 10 is a view of a further alternative embodiment of the handle hook.

FIG. 11 is a view of a further embodiment of the hanger bar.

FIG. 12 is an alternative embodiment for the end cap of the hanger bar.

FIG. 13 is a side view of a still further embodiment of the handle hook for use with a garment hook in a vehicle.

FIG. 14 is an end view of the embodiment of FIG. 13.

FIG. 15 is a view of the hanger pin for use with the hanger hook.

FIG. 16 is a side view of the hanger pin of FIG. 15.

### DESCRIPTION OF THE PREFERRED EMBODIMENTS

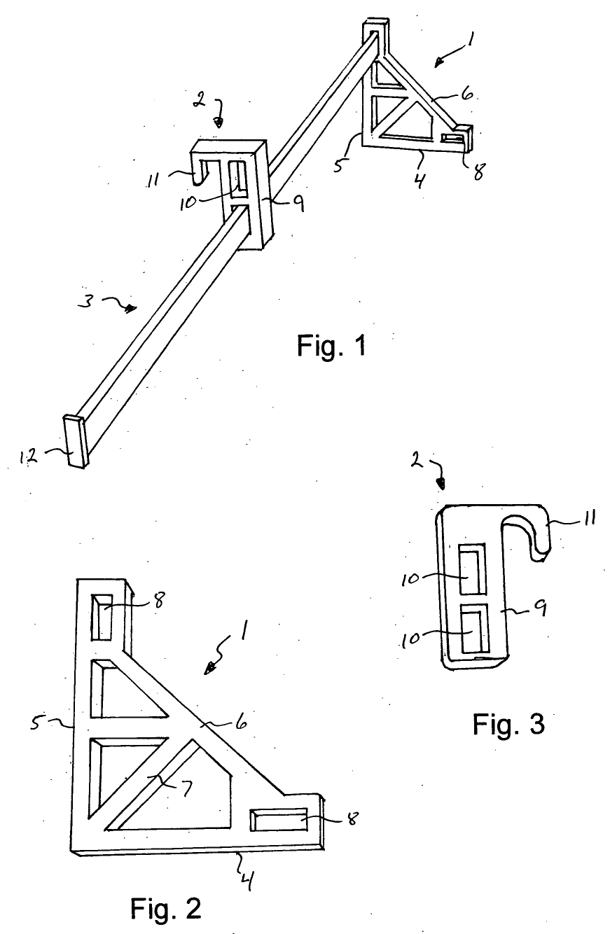

As shown in FIG. 1, the automobile clothes hanger device comprises three elements, a rear support member 1, a hanger hook 2 and a hanger bar 3.

Looking at FIG. 2, the rear support member 1 is a substantially L-shaped structure having unequal length legs 4 and 5 joined at a 90° angle. To provide rigidity, an angle brace 6 extends diagonally between and relative to the ends of the legs 4 and 5. Other bracing 7 may be included as needed depending on the material from which the rear support member 1 is made. Alternatively, rear support member 1 could be a solid piece.

At the end of each leg, 4 and 5 is an aperture 8 extending completely through the rear support member. The shape of the aperture preferably conforms to the shape of the hanger rod 3 so as to be able to receive the ends of the rod 3 therethrough as shown in FIG. 1. In the preferred embodiment of FIGS. 1-3, the hanger rod is rectangular in cross-section so that the apertures 8 are also rectangular. In this embodiment, the apertures 8 are slightly larger than the outer dimensions of the hanger rod 3 to permit ease of assembly and sliding adjustment.

Rear support member 1 may be made from any material suitable for molding or machining. However, in the interest of safety and to reduce the possibility of damage to vehicle interiors, rear support member is preferably made from plastic or resin materials which may include reinforcing to provide sufficient rigidity to support clothing. A preferred material for manufacturing rear support member 1 is molded nylon since it provides sufficient rigidity, but has a soft feel against other materials commonly used in vehicle interiors.

Handle hook 2 is shown in FIG. 3 and consists of an elongated rectangular body portion 9 having two apertures 10 therein. Like apertures 8 of the rear support member, apertures 10 conform to the shape of the hanger rod 3 and have dimensions that are slightly larger than the outer dimensions of hanger rod 3 to permit ease of assembly and sliding adjustment.

Extending laterally from one end of the rectangular body portion 9 is a hook 11 formed as an integral part of handle hook 2 and sized to fit over the grab handle of an automobile. By locating hook 11 at one end of the body portion, handle hook 2 can be suspended from an automobile grab handle such that body portion 9 and apertures 10 are at a level whereby hanger rod 3 when inserted into apertures 10, will not be at a level to obscure the vision of the driver of the vehicle.

In addition, hook 11 can be made with a thickness sufficient such that, when positioned on a grab handle which is normally recessed within the ceiling of a vehicle, it will bias the grab handle outward so as to position the hanger rod 3 a sufficient distance from the interior surface of the vehicle to reduce the tendency of clothes hung on hanger rod 3 to bunch up against the side of the passenger compartment.

Handle hook 2 is preferably made from the same material as rear support member 1 and it is important that the material of handle hook have sufficient rigidity to prevent hook 11 from flexing and losing support.

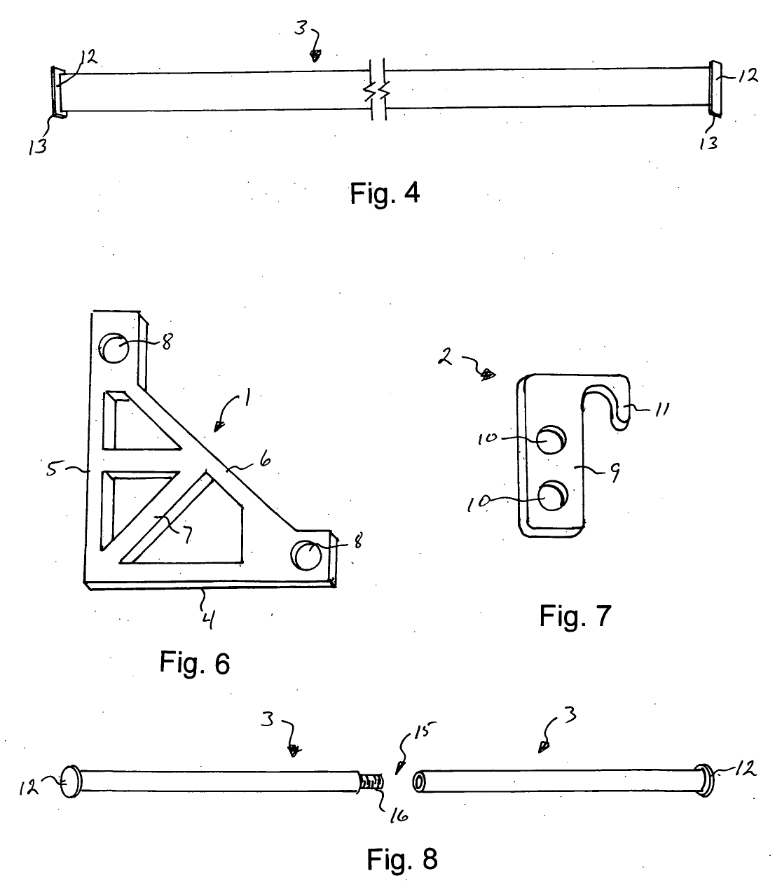

Hanger rod 3, seen in FIGS. 1 and 4, is preferably a single length to span the distance between the rear package shelf and the front seatback in a vehicle and may be tubular aluminum or powder coated steel. Other materials may be used, such as wood, reinforced plastics, and the like, provided they have sufficient rigidity. In the principal embodiment as shown in FIG. 1, hanger rod 3 is rectangular in cross section and is provided with end caps 12 at each end. In addition to closing the ends of the hollow structure of hanger rod 3, end caps 12 also provide a means to releasably secure hanger rod 3 in the apertures 8 and 10 of rear support member 1 and handle hook 2. Peripheral edges 13 of end caps 12 extend peripherally outward beyond the planar surfaces of hanger rod 3 a short distance. Also, apertures 8 and 10 have dimensions that match the outer peripheral edges 13 of the end caps 12 so that end caps 12 can pass through apertures 8 and 10. In particular with respect to rear support member 1, hanger rod 3 is inserted through aperture 8 therein. Because aperture 8 is the same dimension as end cap 12, end cap 12 passes through and hanger rod 3 drops into place within aperture 8. Since the outer peripheral edges 13 of end cap 12 extend beyond the planar surfaces of hanger rod 3, hanger rod 3 is effectively slightly smaller than apertures 8 and will settle into place on the bottom edge of aperture 8 so that the lower peripheral edge 13 of end cap 12 extends below the bottom edge of aperture 8 and engage the rear surface of rear support means 1 thereby preventing hanger rod 3 from pulling back through aperture 8.

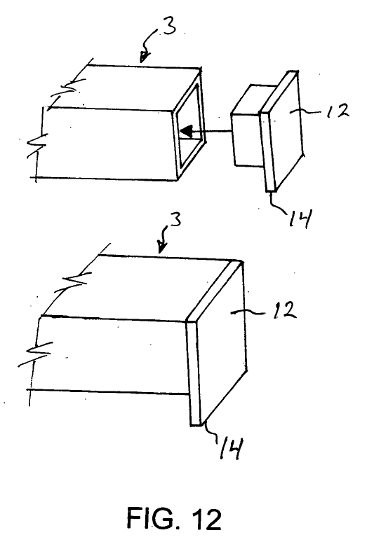

Alternatively, apertures 8 and 10 and hanger rod 3 are the same size and end caps 12 have a single flange 14 along a lower edge as shown in FIG. 12. In this embodiment, hanger rod 3 is inserted through aperture 8 or 10 by angling hanger rod 3 relative to rear support member 1 or handle hook 2 so that flange 14 passes through aperture 8 or 10 first. Hanger rod 3 is then straightened to pass through aperture 8 or 10 and flange 14 depends below the bottom edge of aperture 8 or 10 to serve as a detent against the face of rear support member 1 or handle hook 2 to prevent hanger rod 3 from inadvertently pulling free.

Alternative embodiments of the automobile clothes hanger of the present invention are shown in FIGS. 6-11. For example, although the preferred embodiment is for hanger bar 3 and the corresponding apertures in rear support member 1 and handle hook 2 to be rectangular in shape, other shapes are possible, for example, triangular, hexagonal or, as shown in FIGS. 6-8, round. In this embodiment, apertures 8 and 10 are substantially circular and hanger bar 3 has a corresponding circular cross section. Also, end caps 12 are circular in plan. In addition, this embodiment illustrates that hanger bar 3 may be provided in sections connectable by releasable connecting means 15, such as a bayonet connector, friction connector or, as shown cooperating threads 16.

Alternatively, hanger bar 3 may be adjustable in length by means of telescopic sections 17 and 18 as shown in FIG. 11. The telescopic sections 17 and 18 may include releasable detents to hold their relative positions or a simple friction collar 19 on the outer telescopic section 18 through which inner telescopic section 17 passes and is held in relative position may be used.

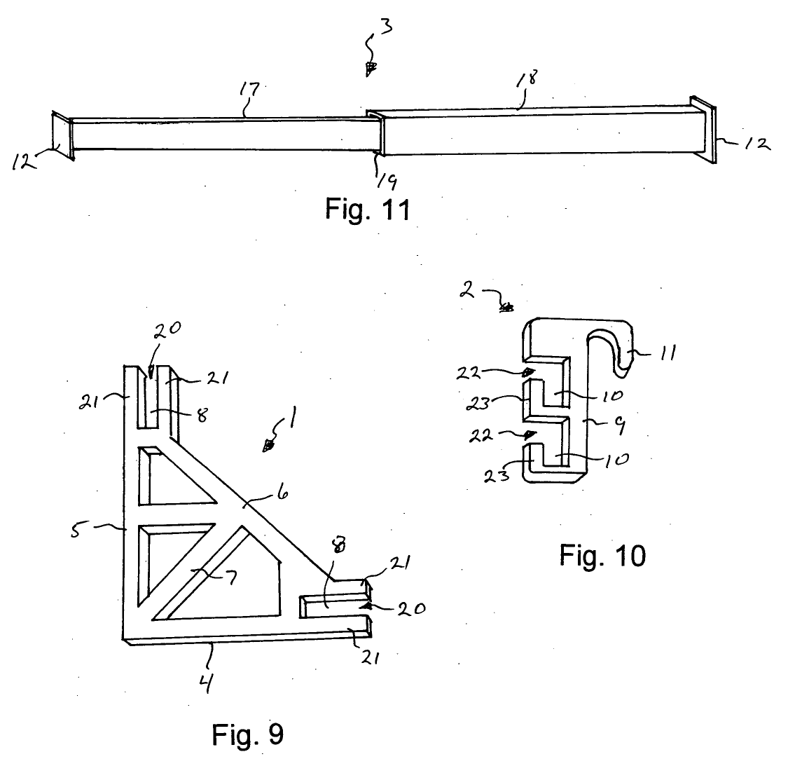

In addition, FIGS. 9 and 10 illustrate alternative structures for apertures 8 and 10 in rear support member 1 and handle hook 2. In rear support member 1, apertures 8 are open at the outer ends of legs 4 and 5 permitting hanger bar 3 to be simply slipped into place through the end openings 20. The parallel arms 21 on either side of aperture 8 have sufficient rigidity to hold hanger bar in place when rear support member 1 is upright.

In the case of handle hook 2, lateral openings 22 into apertures 10 on the side of body 9 opposite to hook 11 allow hanger bar 3 to be slipped sideways into aperture 10. Since openings 22 are only at most half the depth of apertures 10, the remaining side walls 23 of apertures 10 hold hanger bar 3 in place.

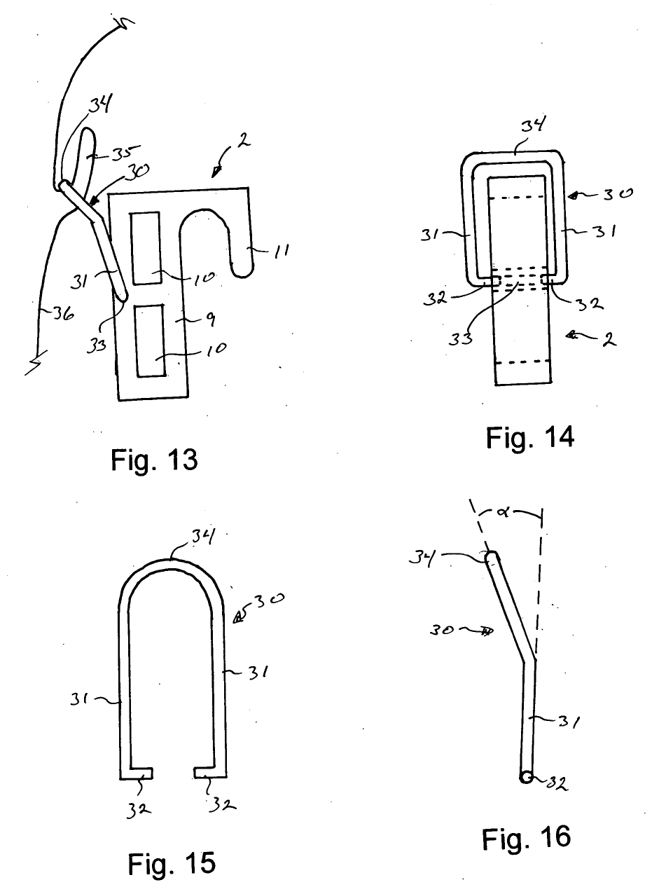

For those vehicles having a garment hook 35 with or without a grab handle 28, FIGS. 13-16 illustrate an embodiment of the present invention for use with such garment hooks 35.

As shown in FIGS. 13 and 14, handle hook 2 is provided with a hanger pin 30 on the side opposite hook 11. Hanger pin 30 is a loop, preferably of metal wire with a vinyl coating, but may be of reinforced plastic or other suitable material, having parallel depending legs 31. The ends of legs 31 are bent inward toward each other to form attachment pins 32 which are inserted into a through hole 33 formed in the body 9 of the handle hook 2 substantially between apertures 10. To ensure that handle hook 2 hangs away from the inside wall 36 of the passenger compartment, the upper loop end 34 of hanger pin 30 is bent at an angle α of about 20°-30° relative to the legs 31 as shown in FIG. 16.

To use hanger pin 30, attachment pins 32 are inserted into through hole 30 on each side of body 9 such that hanger pin 30 is on the side of handle hook 2 opposite hook 11 with the upper end angled away from handle hook 2 as shown in FIG. 13. With this configuration, the loop end 34 is placed over the vehicle garment hook 35 such that handle hook 2 hangs and supports hanger bar 3 in the same manner as when handle hook 2 is used with the grab handle 28.

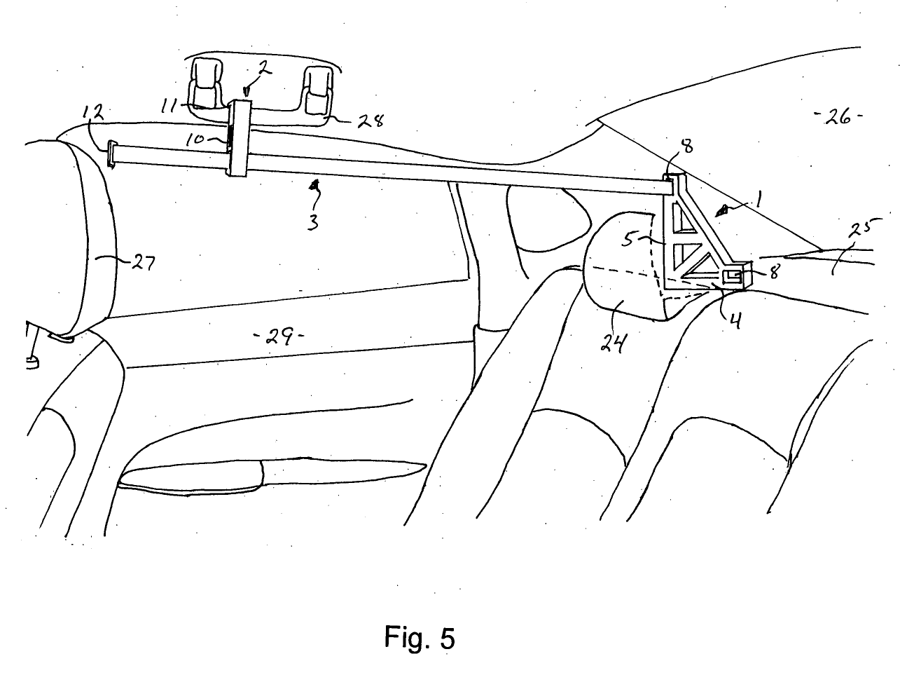

FIG. 5 illustrates the automobile garment hanging device of the present invention in place within an automobile interior. In use, one end of hanger rod 3 is inserted through aperture 8 at the end of one leg 4 or 5 of rear support member 1. The appropriate leg 4 or 5 of rear support member 1 is selected based on the height of the rear seatback or head rest 24 of the vehicle in which the device is to be placed. For higher seatbacks or head rests, the longer leg 5 of rear support member 1 is used, whereas for lower seatbacks or head rests, the shorter leg 4 is used. With rear support member 1 in place on one end of hanger rod 3, the other end of hanger rod 3 is inserted through an aperture 10 of handle hook 2. Again, the aperture 10 that is used is determined by the height of the rear seatback or head rest and the level at which the user desires hanger bar 3 to be suspended.

With the three parts assembled, the device is then place in the rear passenger compartment of a vehicle as shown with rear support member placed upright on the rear package shelf 25 of the vehicle, behind the rear seatback or head rest 24, on the leg not used for the hanger bar 3. End cap 12 of hanger bar 3 should be against the rear face of rear support member 1 to prevent any possible damage to the vehicle rear window 26. With hanger bar 3 extending forward toward the front seat head rest 27, handle hook 2 is slid along hanger bar 3 to a position where it can be suspended from grab handle 28 by hook 11.

With the device in place, clothes may be hung on hanger bar 3 using common clothes hangers. Because hanger bar 3 is suspended at a height at or just above the level of the rear seatback and the front seat head rests, clothes suspended from hanger bar 3 will actually hang slightly below the level of the seatbacks and head rests, thereby not impeding the driver's view through the rear window 26. In addition, clothes hung on hanger bar 3 will hang parallel to the rear seatback 24 so that they will lie flat against the seatback 24 and each other without bunching thereby reducing wrinkling. Furthermore, clothes on the hanger bar are readily accessible through the door 29 of the vehicle.

Although shown positioned on the right side of a vehicle, the automobile garment hanging device of the present invention may be used on the left side of the vehicle simply by reversing the orientation of rear support member 1 and handle hook 2.

The present invention has been described in relation to the preferred embodiment thereof. One of ordinary skill in the art, after reading the foregoing specification, may be able to affect various changes, substitutions of equivalence, modifications and other alterations without departing from the overall intent and scope of the inventive concepts disclosed herein. It is therefore intended that the invention described herein only be limited by the scope of the following claims.

I claim:

1. An automobile garment hanging device comprising:
a rear support member adjustable to different heights,
a handle hook removably attachable to an automobile grab handle, and
a hanger bar longitudinally suspendable between said rear support member and said handle hook within a vehicle interior.

2. The automobile hanging device of claim 1, wherein said rear support member comprises a substantially L-shaped bracket having unequal length legs.

3. The automobile hanging device of claim 2 wherein said rear support member comprises at least one aperture at the end of each leg, said apertures adapted to removable receive one end of said hanger bar.

4. The automobile garment hanging device of claim 1 wherein said handle hook comprises an elongated body and a hook portion extending laterally from one end of said body and adapted to engage said grab handle.

5. The automobile garment hanging device of claim 4 wherein said handle hook further comprises upper and lower apertures in said elongated body, said apertures adapted to slidably receive said hanger bar.

6. The automobile garment hanging device of claim 1 wherein said hanger bar comprises an elongated rod adapted to engage and be suspended between said rear support member and said hanger hook.

7. The automobile garment hanging device of claim 6 wherein said hanger bar further comprises an end cap on each end of said rod, each end cap having a periphery extending laterally outward from said rod and engaging said rear support member and said hanger hook when said rod is passed through said apertures.

8. The automobile garment hanging device of claim 7 wherein said hanger bar comprises a single length rod adapted to span a distance within an automobile passenger compartment between the rear window and the front seatback thereof.

9. The automobile garment hanging device of claim 7 wherein said hanger bar comprises at least two telescopically collapsible and extendable sections adapted to adjustably span a distance within an automobile passenger compartment between the rear window and the front seatback thereof.

10. The automobile garment hanging device of claim 7 wherein said hanger bar comprises at least two rod sections having cooperative releasable connecting means, said hanging bar being thereby adjustable to span a distance within an automobile passenger compartment between the rear window and the front seatback thereof.

11. An automobile garment hanging device comprising:
a rear support member comprising a substantially L-shaped bracket having unequal length legs, each leg having an aperture at the free end thereof, said bracket adapted to be positioned on a rear window shelf of an automobile passenger compartment,
a handle hook comprising an elongated body having upper and lower apertures therein and a hook member extending laterally from one end of said body adjacent to said upper aperture, said hook member adapted to engage an automobile grab handle whereby said elongated body is suspended from said grab handle, and
an elongated hanger bar engagable with one of said apertures in said rear support member and one of said apertures in said handle hook to be suspended therebetween over a rear seat of an automobile to receive clothes hangers thereon.

12. The automobile garment hanging device of claim 11 wherein each end of said hanger bar has an end cap with a peripherally extending flange capable of passing through said apertures in said rear support member and said hanger hook and then engaging the surface of said rear support member and said hanger hook thereby resisting removal therefrom.

13. The automobile garment hanging device of claim 12 wherein said hanger bar comprises a single length rod.

14. The automobile garment hanging device of claim 12 wherein said hanger bar comprises at least two telescopic rod sections.

15. The automobile garment hanging device of claim 12 wherein said hanger bar comprises at least two separable rod sections having cooperable, releasable connecting means.

16. The automobile garment hanging device of claim 12 wherein said apertures in said rear support member are open at the end of each leg forming a U-shaped receptacle in which said hanger bar is received, said flange of said end cap being engagable with the surface of said rear support member whereby said hanger bar is held within said U-shaped receptacle.

17. The automobile garment hanging device of claim 16 wherein said apertures in said handle hook each have a side opening on the side of said body opposite to said hook member whereby said apertures have an upward hook shape in which said hanger bar is received, said flange of said end cap being engagable with the surface of said handle hook whereby said hanger bar is held within said hook-shaped apertures.

18. The automobile garment hanging device of claim 1 further comprising an auxiliary hanger pin removably attachable to said handle hook, said hanger pin comprising a loop portion and depending legs, whereby said depending legs comprise means to engage and hold said pin to said handle hook and said loop portion is adapted to engage a garment hook in an automobile.

19. The automobile garment hanging device of claim 11 further comprising an auxiliary hanger pin removably attachable to said handle hook, said hanger pin comprising a loop portion and depending legs, whereby said depending legs comprise means to engage and hold said pin to said handle hook and said loop portion is adapted to engage a garment hook in an automobile.
